(19) United States
(12) Patent Application Publication
(10) Pub. No.: US 2016/0165866 A1
(43) Pub. Date: Jun. 16, 2016

(54) Customizable Fishing Lure

(71) Applicant: Adam LaMey, Clarks Summit, PA (US)

(72) Inventor: Adam LaMey, Clarks Summit, PA (US)

(21) Appl. No.: 14/963,390

(22) Filed: Dec. 9, 2015

Related U.S. Application Data
(60) Provisional application No. 62/089,955, filed on Dec. 10, 2014.

(51) Int. Cl. A01K 85/18

(52) U.S. Cl. CPC A01K 85/18

(57) ABSTRACT

A customizable fishing lure having an inner shell and an outer shell. The inner shell includes a first section removably securable to a second section, and defines an interior volume in which beads, weights, or other objects can be positioned. The interior volume of the inner shell includes one or more compartments for storing the beads and weights so as to adjust the distribution of weight within the inner shell. In some embodiments, the inner shell further includes hooks or a bill thereon. The outer shell includes a first section removably securable to a second section, wherein the outer shell includes a decorative appearance resembling a fish or bait. The outer shell encloses the inner shell therein and may be removably secured to the inner shell.

### CROSS REFERENCE TO RELATED APPLICATION

This application claims the benefit of U.S. Provisional Application No. 62/089,955 filed on Dec. 10, 2014. The above identified patent application is herein incorporated by reference in its entirety to provide continuity of disclosure.

### BACKGROUND OF THE INVENTION

### Field of the Invention

The present invention relates to fishing lures. More specifically, the present invention provides a customizable fishing lure comprising an inner shell in which various objects and weights can be placed, and an outer shell adapted to enclose the inner shell, wherein the outer shell resembles fish or other live bait.

Fishermen use various types of bait and lures in order to catch fish. Further, certain types of bait or lures may be required in order to attract and catch specific types of fish. Thus, a fisherman must possess several types of bait and lures. Conventional bait and lures are not adjustable or customizable, requiring fishermen to switch between different types of bait or lures for fishing in different locations and when fishing for different types of fish. Thus, a lure that can be adjusted and customized so as to serve different purposes is desired.

Devices have been disclosed in the prior art that relate to fishing lures having interchangeable bodies or parts. These include devices that have been patented and published in patent application publications. U.S. Published Patent Application Number 2013/0199080, U.S. Pat. No. 2,587,736, U.S. Pat. No. 5,301,453, and U.S. Pat. No. 7,827,731 relate to fishing lures having interchangeable lure bodies. Other devices provide fishing lures with removable and interchangeable tail sections, such as U.S. Published Patent Application Number 2012/0000111.

These prior art devices have several known drawbacks. Fishing lures in the prior art fail to disclose a fishing lure having an inner shell adapted to receive various objects, such as weights or beads, and that further includes an outer shell adapted to enclose the inner shell, wherein the outer shell is adapted to resemble live bait such as a small fish. Thus, the prior art fishing lures cannot be adjusted in weight and/or movement by the addition of objects, such as weights or beads.

In light of the devices disclosed in the prior art, it is submitted that the present invention substantially diverges in design elements from the prior art and consequently it is clear that there is a need in the art for an improvement to existing fishing lure devices. In this regard the instant invention substantially fulfills these needs.

### SUMMARY OF THE INVENTION

In view of the foregoing disadvantages inherent in the known types of fishing lures now present in the prior art, the present invention provides a new fishing lure wherein the same can be utilized for providing convenience for the user when adjusting or customizing the appearance and operation of a lure.

It is therefore an object of the present invention to provide a new and improved fishing lure device that has all of the advantages of the prior art and none of the disadvantages.

It is another object of the present invention to provide a fishing lure device comprising an inner shell having removably connected first and second sections adapted to be enclosed within an outer shell also having removably connected first and second sections.

Another object of the present invention is to provide a fishing lure having an inner shell with an interior volume in which weights and other objects can be positioned in order to affect the movement of the lure in the water.

A further object of the present invention is to provide a fishing lure having an inner shell with one or more compartments for holding various objects therein.

Yet another object of the present invention is to provide a fishing lure having an outer shell having a decorative appearance resembling a fish or other live bait.

An additional object of the present invention is to provide a fishing lure having a bill removably securable thereto, wherein the bill is adapted to impact the movement of the fishing lure within the water.

Another object of the present invention is to provide a fishing lure that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a disassembled view of the fishing lure.

FIG. 2 shows a side cross sectional view of an embodiment of the fishing lure having interior fasteners.

FIG. 3 shows a disassembled view of the inner shell of the fishing lure.

FIG. 4 shows a view of the outer shell of the fishing lure.

FIG. 5 shows a perspective view of an alternate embodiment of the fishing lure.

### DETAILED DESCRIPTION OF THE INVENTION

Reference is made herein to the attached drawings. Like reference numerals are used throughout the drawings to depict like or similar elements of the fishing lure. For the purposes of presenting a brief and clear description of the present invention, the preferred embodiment will be discussed as used for providing a customizable fishing lure that can be adjusted in appearance and operation. The figures are intended for representative purposes only and should not be considered to be limiting in any respect.

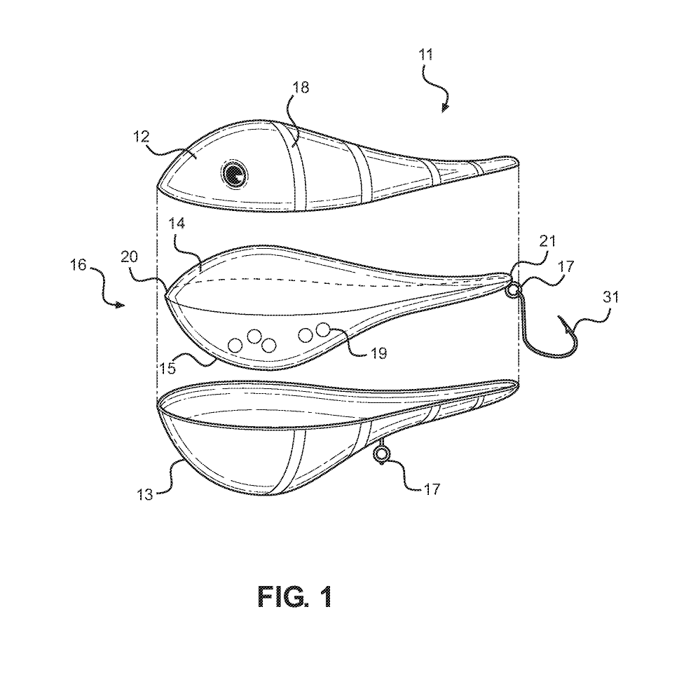

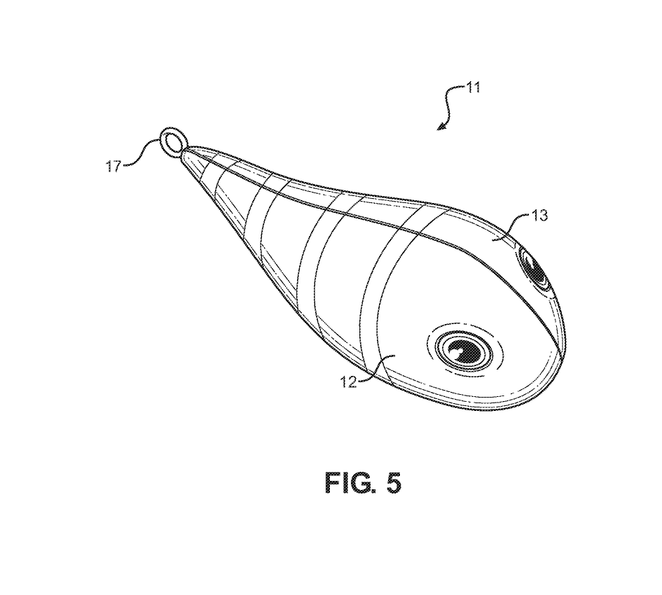

Referring now to FIG. 1, there is shown a disassembled view of the fishing lure of the present invention. The fishing lure 11 comprises an inner shell 16 and an outer shell. The inner shell 16 includes a first section 14 removably securable to a second section 15. In some embodiments, the inner shell 16 is divided into the first section 14 and second section 15 via a horizontal plane that extends from the front end 20 to the rear end 21 so as to create an upper and lower half. In alternate embodiments the inner shell 16 is divided by a vertical plane extending from the front end 20 to the rear end 21 so as to divide the fishing lure 11 into a left and right half, as shown in FIG. 5.

The inner shell 16 comprises a hollow interior volume in which one or more objects 19, such as weights, beads and/or ball bearings, among other objects can be disposed. The first section 14 and second section 15 are preferably removably securable to one another via snap connection or via one or more fasteners, such as clips or hooks. The edges of the first section 14 and second section 15 may include a rubber seal thereon for providing a watertight closure. When the first and second sections 14, 15 are secured together the inner shell 16 comprises a continuous outer surface.

The inner shell 16 preferably resembles the shape of a small fish such that a front end 20 of the inner shell 16 is rounded so as to serve as the head of the fish, and the inner shell 16 tapers towards the rear end 21 thereof so that the rear end 21 resembles the tail portion of a fish. The inner shell 16 is preferably transparent so that the objects therein are readily visible, however in alternate embodiments the inner shell 16 may be composed of an opaque or translucent material.

The inner shell 16 further comprises one or more rings 17 thereon. Preferably, at least one ring 17 is positioned on the rear end 21 of the inner shell 16 so that the ring 17 extends from the tail portion of the inner shell 16. In alternate embodiments, the rings 17 extend outward from various locations on the inner shell 16. One or more hooks 31 are removably secured to the rings 17 so as to catch on the mouth of a fish that attempts to bite or eat the fishing lure 11.

The fishing lure 11 further comprises an outer shell having a first section 12 and a second section 13 that are removably securable to one another. The outer shell comprises a hollow interior volume adapted to receive the inner shell 16 therein. In this way, the inner shell 16 can be fully enclosed within the outer shell. The outer shell is preferably divided into a first section 12 and second section 13 via a horizontal plane extending from a front end thereof to a rear end thereof, of via a vertical plane extending from a front end thereof to a rear end thereof, similar to the inner shell 16. In this way, the first section 14 of the inner shell 16 is similar in construction to the first section 12 of the outer shell. Similarly, the second section 15 of the inner shell 16 is similar in construction to the second section 13 of the outer shell. The outer shell further comprises a decorative pattern 18 on the exterior thereof, preferably resembling that of a small fish.

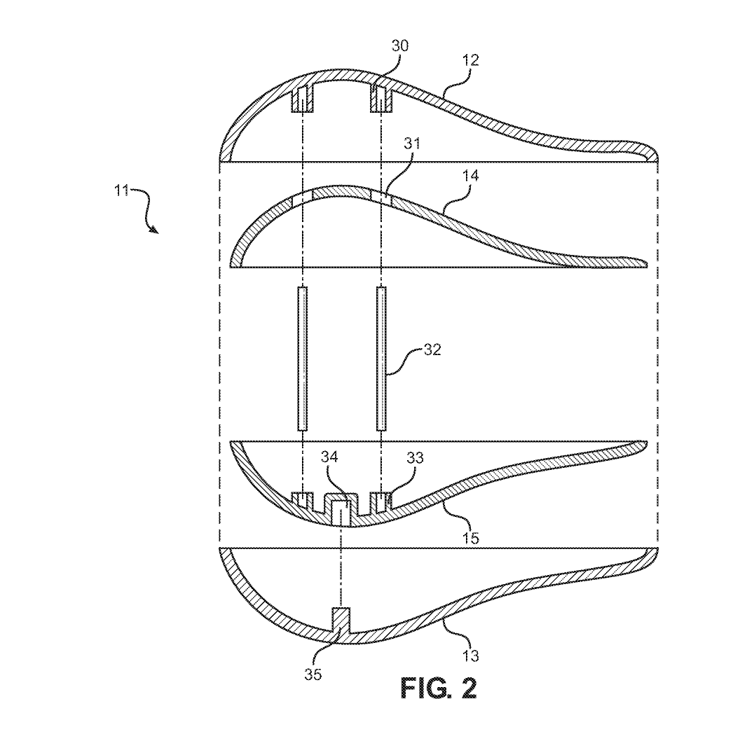

Referring now to FIG. 2, there is shown a side cross sectional view of an alternative embodiment of the fishing lure. In some embodiments, additional fasteners are provided for securing the sections of the inner shell and the sections of the outer shell. Further, in some embodiment, the inner shell is removably securable to the outer shell so that the inner shell does not move within the outer shell during use.

In the illustrated embodiment, the first section 12 of the outer shell comprises one or more channels 30 on an interior portion thereof that are adapted to receive a fastener therein, such as a threaded rod 32. Further, the second section 15 of the inner shell comprises one or more channels 30 on an interior portion thereof. The first section 14 of the inner shell comprises openings 31 therethrough, wherein the openings 31 are aligned with the channels 30 of the first section 12 so as to allow the threaded rod 32 to pass therethrough. In this way, the threaded rods 32 can be affixed to the channels 30 of the first section 12 of the outer shell, extend through the openings 31 on the first section 14 of the inner shell, and are affixed at the opposing end to the second section 15 of the inner shell.

Further, the second section 15 of the inner shell further comprises a slot 34 on an exterior thereof that is adapted to receive a fastener 35 disposed on the interior of the second section 13 of the outer shell. In this way, the second section 13 of the outer shell is removably securable to the second section 15 of the inner shell. The inner shell 16 is secured to the outer shell to provide further security and stability to the fishing lure 11. In alternate embodiments, the internal fasteners can be arranged in various locations so as to provide removably connection between the inner shell and outer shell. It is not desired to limit the specific configuration and type of fasteners used to achieve this goal.

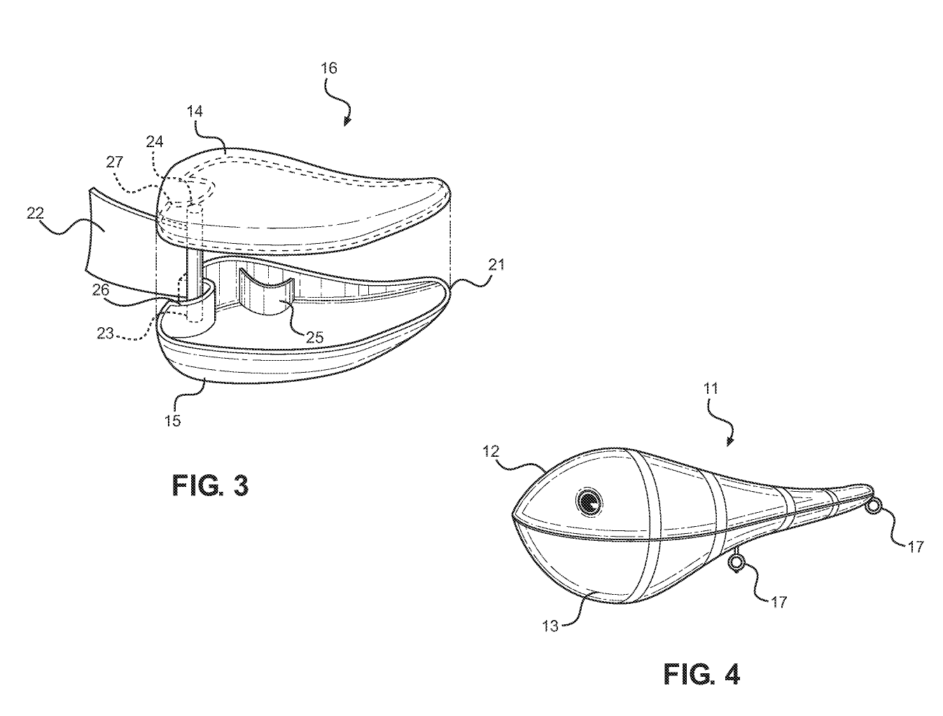

Referring now to FIG. 3, there is shown a disassembled view of the inner shell of the fishing lure. The inner shell 16 comprises a first section 14 and a second section 15. The first and second sections 14, 15 can be removably secured to one another via a press fit or snap connection. The second section 15 includes one or more compartments 25 in which objects, such as weights or ball bearings, can be positioned. The objects serve to increase the weight of the fishing lure 11 allowing the lure to sink to a greater depth in the water. Further, movement of the objects within the hollow interior of the inner shell 16 affects the movement fishing lure 11 within the water, thus attracting more fish due to the more realistic movement of the fishing lure 11 in the water.

In some embodiments, the fishing lure 11 further includes a bill 22 removably securable to a front end of the inner shell 16. In the illustrated embodiment, the bill 22 comprises a flat planar member, adapted to be disposed in a vertical orientation. However, in alternate embodiments, the bill may include an elongated cone or spike. A proximal end of the bill 22 comprises an upper protrusion 24 and a lower protrusion 23 adapted to be inserted into grooves on the front end of the inner shell 16. The front end of the first section 14 and the front end of the second section 15 include grooves 26, 27 adapted to receive the protrusions 23, 24 of a bill 22. The protrusions 23, 24 can pivot within the grooves so that the bill 22 can move as water flows by and around the fishing lure 11. Thus, the bill 22 moves within the water and may impact the movement of the fishing lure.

Referring now to FIG. 4, there is shown a view of the outer shell of the fishing lure. In operation, the user can separate the first and second sections of the inner shell and can insert a desired number of ball bearings, weights, and other objects therein. The user can position the objects in the hollow interior cavity of the inner shell so that the objects can move freely therein, or the user can dispose the objects in a compartment within the inner shell so that the objects are restrained from movement. The user can then seal the first and second sections together to enclose the objects therein.

The user can then select an outer shell having a desired appearance. The outer shell preferably resembles a small fish and may have any of various patterns or colorations. The first and second sections 12, 13 of the outer shell can be positioned over the inner shell so as to enclose the same therein. The outer shell is water tight so that when the fishing lure 11 is used within the water, no water can enter into the interior of the outer shell or the inner shell. The first and second sections 12, 13 may further include one or more rings 17 thereon for securing hooks and other items to the fishing lure 11 in order to catch a fish that is attracted to the fishing lure 11.

As desired, the user can customize the fishing lure 11 and can add or remove objects within the inner shell, and can additionally adjust the positioning of the objects within the inner shell in order to achieve a desired effect. The user can also interchange the outer shells so that the fishing lure resembles various types of fish or other types of bait. In this way, the user is prevented from having to purchase a wide variety of different baits and lures and can instead use a single customizable fishing lure.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A customizable fishing lure, comprising:
an inner shell having a first section removably securable to a second section, wherein said inner shell comprises a hollow interior volume;
an outer shell having a first section removably securable to a second section, wherein said outer shell is adapted to enclose said inner shell therein;
wherein said inner shell comprises a configuration similar to that of a fish, wherein a front end of said inner shell is rounded and wherein said inners shell tapers towards a rear end thereof.

2) The customizable fishing lure of claim 1, wherein said inner shell is divided into a first section and a second section by a horizontal plane extending from a front end of said inner shell to a rear end thereof.

3) The customizable fishing lure of claim 1, wherein said inner shell is transparent.

4) The customizable fishing lure of claim 1, wherein said second section of said inner shell comprises one or more compartments therein.

5) The customizable fishing lure of claim 1, wherein said outer shell comprises a decorative appearance resembling a fish.

6) The customizable fishing lure of claim 1, wherein said outer shell comprises one or more rings thereon adapted to receive a hook.

7) The customizable fishing lure of claim 1, further comprising a bill removably securable to a front end of said inner shell.

8) The customizable fishing lure of claim 7, wherein said bill comprises a planar member.

9) The customizable fishing lure of claim 7, wherein said bill comprises an elongated cone.

10) The customizable fishing lure of claim 7, wherein said bill comprises one or more protrusions adapted to engage with one or more grooves on said front end of said inner shell.
